(19) United States
(12) Patent Application Publication
(10) Pub. No.: US 2020/0305458 A1
(43) Pub. Date: Oct. 1, 2020

(54) METHOD OF STABILIZING PHYSIOCHEMICAL PROPERTIES AND PROLONGING SHELF LIFE OF TEA

(71) Applicant: TEAXPRESS PRIVATE LIMITED, Siliguri (IN)

(72) Inventors: KAUSHAL DUGAR, Siliguri (IN); Nagendranath CHILUVURU, Siliguri (IN)

(21) Appl. No.: 16/307,104

(22) PCT Filed: Apr. 24, 2017
(86) PCT No.: PCT/IN2017/050144

§ 371 Date: Dec. 4, 2018

(30) Foreign Application Priority Data
Jun. 23, 2016 (IN) 201631021596

(51) Int. Cl. A23F 3/30; A23L 3/3418; B65B 31/02; B65B 29/02

(52) U.S. Cl. CPC A23F 3/30; B65B 29/028; B65B 31/024; A23L 3/3418

(57) ABSTRACT

The embodiments herein provides a method of processing to enhance the stability and increase the shelf life of made tea. After procuring the tea from tea gardens and tea estates with the defined characteristic parameters the tea is stored in cold storage. Processed by sorting, grading and filtering out the impurities in the dehumidified environment. Based on projections and order flow the raw materials are treated, blended, vaccumized and nitrogen flushed, in a dehumidified environment and sent for order fulfilment. For packing the graded and stored tea is packed in teabags. The teabags are put in laminated pouches followed by which the pouch with teabag is subjected to gas flushing. The pouches comprising teabags are heat sealed. This innovation is a combination of storage method and packaging technique.

### CROSS-REFERENCE TO RELATED APPLICATION

This Patent Application is a National Phase Application filed corresponding to the PCT Application No. PCT/IN2017/050144 filed on Apr. 24, 2017 with the title “A METHOD OF STABILIZING PHYSIOCHEMICAL PROPERTIES AND PROLONGING SHELF LIFE OF TEA”. This Patent Application claims the priority of the Indian Provisional Patent Application No. 201631021596 filed on Jun. 23, 2016 with the title “A METHOD OF STABILIZING PHYSIOCHEMICAL PROPERTIES AND PROLONGING SHELF LIFE OF TEA”, the contents of which is included herein by the way of reference.

### BACKGROUND

### Technical field

The embodiments herein are generally related to a field of packaging and enhancing stability and shelf life while preserving the freshness of beverages. The embodiments herein are particularly related to a method of stabilizing the physiochemical properties of tea through a packaging method. The embodiments herein is more particularly related to a system and method for stabilization and prolonging the shelf life of tea along with color, aroma and flavor by packaging the tea after removing existing gases and flushing with inert gases.

### Description of the Related Art

Tea is an aromatic beverage commonly prepared by pouring hot or boiling water over cured leaves of the Camellia sinensis, an evergreen shrub native to Asia.

Tea is generally divided into several categories based on a method of processing. At least six different types of tea are known and produced. The six different types of tea are as follows. They are (1) White—wilted and non-oxidized tea, (2) Yellow—un-wilted and non-oxidized tea, but allowed to become yellow, (3) Green un-wilted and non-oxidized tea, (4) Oolong—Wilted, bruised and partially oxidized tea, (5) Black—wilted Tea which is sometimes crushed and fully oxidized, (6) Post fermented—green tea that has been allowed to ferment/compost. The most common types of tea are white, green, oolong and black tea.

A shelf life of the tea is determined based on the storage conditions and type. The shelf life of black tea is greater than that of a green tea. The shelf life of some tea varieties, such as flower tea, may last only for a month. The shelf life of the following varieties of tea such as Pu-erh tea, CTC tea, black tea, yellow tea, green tea, white tea, are respectively in decreasing order.

The tea needs to be stored away from heat, light, air and moisture to keep the tea fresh and to prevent a fungal and mold growth. Tea must be stored in cool dry place away from direct light. Tea may be kept for a longer period of time under this storage method. The life of green tea is deteriorated more rapidly in a year. Tightly rolled gunpowder tea leaves are stored for a longer duration than the more open leafed Chu Mee tea.

The storage life for all tea are extended by using desiccant and oxygen absorbing sachets, vacuum packaging, refrigeration in air tight containers (except for green tea, for which a discrete use of refrigeration or freezing is recommended and a temperature variation has to be kept to a minimum).

When the aroma of tea is degraded, an unpleasant and undesirable aroma, like musty aroma, earthy aroma and woody aroma, is generated. This degradation in aroma substantially reduces the perceived quality of the product. Hence a special attention must be paid to the preparation and storage of products with sensitive composition so that either desirable aroma components are preserved or sometimes enhanced and (or) undesirable components are reduced or sometimes eliminated.

The prior arts disclose the addition of various preservatives to food or beverage products in order to preserve, maintain, or improve the flavour characteristics of such products over time. It is well known in the art that sulphites, sorbic acid, sodium benzoate, potassium bisulphite and sodium and potassium salts of sorbic acid are added to the beverages to preserve the flavours. Generally sulphites act as antioxidants to prevent a deterioration of the flavour. For example, sulphites can react with oxygen to prevent a deterioration of the flavour of the product due to an oxidation of the flavouring component. This is not very effective as the sulfite simply dissolves in the beverage without significantly enhancing or preserving the aroma because the sulfite is added to the whole food matrix and is integrated therein. Prior arts also disclose an addition of sulfite catalase, cysteine or glutathione to beverage, to give an improved beverage aroma, when water is added to reconstitute the beverage. The above mentioned chemical preservatives also interact and react with the metabolic pathways in the human body. This leads to metabolic abnormalities and physiological complications later.

The compounds or agents added to the beverage remain in the product to be consumed. For this reason, the use of sulfites or other additives that remain in the food or beverages after such treatments, is not a desirable solution to this problem. Thus, there still remains a need for stabilization of volatile aromatic components of plant derived products, such as tea to preserve their ability to implant the desired flavor, taste and other sensory characteristic to foods to which they are added. As the artificial food preservatives and flavoring agents have negative impact on the consumer's health.

Hence, there is a need for an alternative method for stabilizing the volatile components and other fixed biochemical components to preserve their ability to impart the desired aroma, flavor, taste and other sensory characteristics of tea. Also there is a need for a method of packaging tea which does not use chemicals and do not cause harm to consumer.

The above mentioned shortcomings, disadvantages and problems are addressed herein and which will be understood by reading and studying the following specification.

### OBJECTS OF THE EMBODIMENTS HEREIN

The primary objective of the embodiments herein are to enhance the stability, thereby increasing the shelf life and preserving the freshness of tea by using specific storage techniques and packaging methods.

Another objective of the embodiments herein are to treat the teabags individually with a gas flushing in a storage environment to provide a non-reactive environment for tea thereby preserving the colour, aroma, flavor, taste and ultimately freshness.

Yet another objective of the embodiments herein is to provide a method of packaging teabags to prevent oxygen induced reactive changes in the tea to avoid degradation of nutritive, aromatic and flavoring compounds.

Yet another objective of the embodiments herein is to provide a modified atmospheric packaging for enhancing the stability there by preserving the freshness and shelf life of tea.

Yet another objective of the embodiments herein is to provide a method of packaging teabags without adding chemical agents, preservatives and additives to tea.

Yet another objective of the embodiments herein is to provide a method of packaging for tea bags by removing the existing gases and subjecting the teabags to gas flushing with gases which have no side effect on consumer or physiochemical nature of tea.

Yet another objective of the embodiments herein is to design a technique to enhance the stability and shelf life of tea by the integration of storage methods and packaging techniques.

Yet another object of the embodiments herein is to pack whole leaf (Orthodox leaf) teas in teabag with Nitrogen gas flushing while removing the existing gases.

Yet another object of the embodiments herein is to pack tea bags after treating each tea bag individually with Nitrogen flushing process.

Yet another object of the embodiments herein is to process and treat the different types of tea which includes tea procured from a single estate, a blend of tea comprising tea procured from several estates and a blend of tea comprising tea procured from one or more tea estates and one or more flavoring agents.

These and other objects and advantages of the embodiments herein will become readily apparent from the following detailed description taken in conjunction with the accompanying drawings.

### SUMMARY

The embodiments herein provide a method for storage and packaging of blended/single estate tea by providing a non-reactive environment for tea bags for enhancing the stability of biochemical components and for increasing the shelf life of tea while preserving the quality and freshness. The method comprises procuring tea from one or more tea gardens through mapping of tea plantation. The procurement of tea is carried out at a plurality of flush timings to obtain tea with varying liquor characteristics. A batch sample is identified from the procured tea and matching of the batch sample is confirmed with a previously shortlisted tea sample based on a plurality of predetermined quality specifications. The procured tea is rejected when the batch sample does not match with the shortlisted tea sample. The procured tea is stored in a cold storage for retaining quality, composition, flavor and color. The procured tea is further processed using sorting and grading technique. The tea is subjected to a quality check before and after processing to meet a plurality of predetermined quality specifications. The tea is reprocessed on failure of the quality check. The processed tea is packaged in tea bags. Each tea bag is individually put in pouch/envelop, gas flushed with nitrogen to remove the existing atmospheric gases and retain nitrogen to avoid oxidative deterioration and for inhibiting growth of micro-organisms. The pouch/envelop is heat sealed. The pouches are processed to remove the existing gases, gas flushed and heat sealed during packaging for enhancing the stability and increasing the shelf life of tea.

According to one embodiment herein, the plurality of predetermined quality specifications comprise physical, chemical and microbial quality specifications that the tea and tea bags/pouches need to meet at various stages of tea processing.

According to one embodiments herein, the plurality of physical quality specifications comprise non-contamination of tea from living insects, moulds, dead insects, insect fragments and rodent as visible to naked eye, flavour of tea free from any off odour, taint and mustiness, sensory evaluation of the tea greater than 7 points on a scale of 10 points, porosity of tea bag material, tensile strength of a tea bag tag, thickness of pouch material and intactness of sealing.

According to one embodiment herein, one or more sensory parameters considered during sensory evaluation of tea include but not limited to dry leaf bloom, dry leaf aroma intensity, wet leaf colour, wet leaf aroma intensity, liquor colour, liquor aroma intensity, liquor astringency, liquor strength, liquor flavor, liquor bitterness, and liquor after taste.

According to one embodiment herein, the plurality of chemical quality specifications comprises a moisture content of tea between 2% to 5%, a water soluble ash of tea in the range of 4% to 8%, an acid insoluble ash of tea less than 1% and a water extract of tea more than 32%.

According to one embodiment herein, the plurality of microbial quality specifications comprise an absence of pathogenic micro-organisms in the tea and a total plate count of tea below 100000 cfu/g.

According to one embodiment herein, the gases used for flushing the tea bags and pouches are nitrogen, carbon dioxide, argon and a mixture of inert gases. The gas pressure during gas flushing of tea bags is maintained at about 1 bar and temperature of gas while applying gas to the tea bags is maintained below 5° C.

According to one embodiment herein, the method further comprises procuring non-tea ingredients (flavoring agents), through the process of sampling, subjecting the non-tea ingredients to a quality check and storing the non-tea ingredients in a cold storage.

According to one embodiment herein, the method further comprises developing a blended tea by blending stored tea and non-tea ingredients. The blended tea is packaged in tea bags by removing existing gases by gas flushing.

According to one embodiment herein, the blended tea comprises tea leafs procured from one or more tea estates.

According to one embodiment herein, the blended tea comprises tea leafs procured from one or more tea estates and one or more flavoring agents.

According to one embodiment herein, the packaging material used for making tea bags and pouches comprise biaxial oriented polypropylene (BOPP), metalized polyester (MET-PET) and polyethylene (PE).

According to one embodiment herein, each tea bag is individually nitrogen flushed and packed.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flow chart explaining the steps of tea processing for increasing the shelf life of tea, according to one embodiment herein.

FIG. 2A-2B illustrates a flow chart collectively explaining the steps of straight tea bag packaging, according to one embodiment herein.

FIG. 3 illustrates a flow chart explaining the steps of blended tea bag packaging, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

The following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a method of packaging and non-reactive environment for teabags. The embodiments herein also provide a treatment method for teabags with a combination of gas flushing in a storage environment to provide a non-reactive environment for tea thereby preserving the color, aroma, flavor and ultimately freshness.

Tea is hygroscopic by nature. Tea is degraded and deteriorated by oxidation and moisture. The air and moisture content present in the teabags reacts with the essential oil of tea and induce rancidity. The rancidity degrades the flavor, oils, aroma of the tea. Oxygen is responsible for oxidative changes.

According to one embodiment herein, the method of stabilizing physiochemical properties and prolonging shelf life and preserving the freshness and quality of tea comprises the following steps. The first step is procurement of tea from tea gardens and procuring the non-tea ingredients (flavoring agents). The next step is subjecting the tea in a cold storage. The tea and the non-tea ingredients are subjected to sampling. Based on the flow of orders the tea is taken from cold storage and pre-treated. The pre-treated tea is packed in tea bags and the tea bags are put in tea pouches/envelops followed by which the tea pouches are nitrogen gas flushed and heat sealed. For the preparation of flavored tea, the tea is pre-treated, blended with the flavoring agents. After blending the tea with flavoring agents, the flavored tea is packed in tea bags. The tea bags are put in tea pouches followed by which the tea pouches/envelops are gas flushed and heat sealed.

According to one embodiment herein, a method is developed to remove the existing gases in the tea before packing and flushing the teabags with gases. The tea bag is gas flushed to remove the moisture content and the oxygen and other trace gases. The teabag in the tea pouch is subjected to gas (nitrogen) flushing to eliminate any traces moisture and atmospheric gases and then heat sealed. The gas flushing is performed to preserve the quality and freshness of tea for more than 24 months after packing.

According to one embodiment herein, each tea bag is individually put in a pouch/envelop, nitrogen flushed and heat sealed.

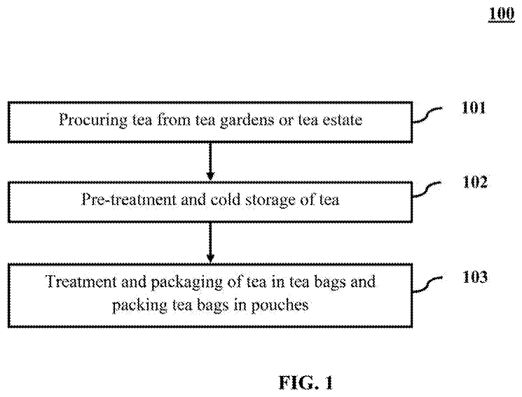

FIG. 1 is a flow chart illustrating the steps of tea processing for increasing the shelf life of tea, according to one embodiment herein. The first step is procuring tea from tea gardens or tea estates (101). The tea is pre-treated and subjected to cold storage (102). The tea is treated and packaged in teabags. The teabags are packed in pouches (103). The tea bags are treated with nitrogen gas flushing to remove all the atmospheric gases and moisture which otherwise reacts with biochemical components of tea to deteriorate the freshness and quality of tea.

According to one embodiment herein, the method of procuring the tea form the tea gardens comprises the following steps. A communication of the projections for procurement is made with the head offices of the tea gardens or the tea estate. The communication is made 1 week after the finalization of the projection. Prior to the starting of the flush, the team moves to the gardens to analyse the flush of the respective tea. The flush indicates the plucking time. The analysis is made for a plurality of parameters that includes but not limited to a quality of flush, estimation of the arrival of the peak quality period and the flush time period. The mapping is completed one week prior to the start of the flush. Focus is made on the small plantation growers of the tea plants, as the tea plants are young and the tea aroma has sufficient vigour. The characteristic parameters of the tea are defined to pluck and process the tea accordingly. The date of the manufacture of the tea is finalized.

After plucking the tea leaves from tea gardens and tea estates, the tea leaves are processed. As soon as the tea leaves are processed, the tea leaves are packed in the paper bags, jute bags, laminated bags, LDPE bags and stored in the warehouse by the plantation growers. The plantation/garden or the head office sends the offer sample. The average flush period is more than 1.5 months on the date of manufacture of the offer sample provided by the garden or tea estate owners. Sensory profiling and evaluation of the offer Sample (Tea) is done in one day. When the tea leaves meets sensory parameters and quality parameters, the price is negotiated. After negotiating the price, a procurement of tea leaves is made accordingly. The procurement of the tea leaves is made on the same day of the tea sampling. Tea leaves comes from the gardens to warehouse. After the arrival of the tea leaves in the warehouse, the tea leaves are vacuum packed and stored in the cold storage in less than an hour or two. On the basis of projection and flow of sales order, stored tea leaves are taken out from the cold storage and kept in the dehumidified environment in a sealed condition. The tea leaves are kept in a dehumidified environment to bring the temperature of the tea leaves to ambient conditions and temperatures while prevent moisture absorption by the hygroscopic tea. After bringing the tea leaves to ambient conditions, the tea is processed. The tea is processed for sorting, grading and filtering out the impurities in the dehumidified area. On the basis of projected sales order, the tea leaves are vacuum packed (in case of loose leaf tea) or nitrogen gas flushed (in case of teabags) and packaged in the dehumidified environment before being sent to customers for fulfilment of sales order as per the requirement.

Table 1 below illustrates the types of flush, flush period and the time of procurement:

| | Types of | Flush | Procurement |
|---|---|---|---|
| Sl. No. | Flushes | Period | Period |
| 1. | First Flush | 1^{st} week of March- | 20^{th} march- |
| | | Mid April | 5^{th} April |
| 2. | Second Flush | 1^{st} week of June- | 15^{th} June- |
| | | July End | 10^{th} July |
| 3. | Autumn Flush | 20^{th} October- | 25^{th} October- |
| | | 10^{th} November | 5^{th} November |
| 4. | Winter Flush | Last week of December- | Mid of January- |
| | | Mid February | End of January |

According to one embodiment herein, the first flush is the first plucking after the dormant winter months. The leaves are tender and very light green in appearance. The liquor is light, clear, and bright with a pleasant brisk flavor. The second Flush is known for its quality. The liquor is round and mellow with more amber color and a slightly fruity flavor. During this period, the “Muscatel” flavor, for which Darjeeling is known, becomes pronounced. The third flush is the longest plucking period. This is when the monsoon starts and the heavy rains come. The liquor gets stronger but the overall quality generally suffers during this time. In the fourth flush, the tea has a light coppery tinge and the liquor has a delicate character.

According to one embodiment herein, the steps of pre-treatment process of the tea leaves before cold storage are as follows. Tea leaves are received from the plantation or tea estate in paper bags and wooden boxes at the warehouse. After the sensory analysis and comparison of the purchase sample with offer sample, the tea leaves are vacuum packed in bulks of 20 kg. The 20 kg bulk packs are then placed in a corrugated boxes, sealed and shrink wrapped to avoid moisture migration from the cold storage to the tea. The time required for shrink wrapping and placing tea bulk packs in cartons takes less than an hour. The cartons are labeled as per stock keeping unit (SKU), weighed and an invoice number is made. The shrink wrapped corrugated boxes with bulk packs of tea are bar-coded and placed in the cold storage.

As per the sales orders and requirement, the tea is brought from the cold storage and kept in a dehumidified environment for a time period of 24 hours. After 24 hours, the pack is opened and the tea is subjected to sorting and grading. The tea is repacked in 100 gram vacuum packets after nitrogen flushing (in case of loose leaf tea) or each tea bag is individually Nitrogen flush packed (in case of tea bags). After repacking, the packs are labeled. These gas flushed packs of tea are used for order fulfillment. The packaging process is completed in less than 3 hours.

The conditions under which the tea is stored in cold storage are as follows. The temperature maintained at cold storage is 2-5° C. The relative humidity in the dehumidified area is maintained between 32-37%. The storage life of tea is extended by refrigeration using cold storage. Low temperature storage (between 0° C. to 5° C.) decreases water activity, slows down the chemical and biological processes and reduces the accompanying deterioration of biochemical compounds and loss of quality.

According to one embodiment herein, the steps for treatment and packing the tea in teabags and tea pouches are as follows. The graded and stored tea is packed in nylon teabags. Each teabag is put in pouch/envelop. Nitrogen gas flushed into pouches with teabag at a pressure of 10.0-15.2 Pa for 3-4 seconds. The nitrogen gas is selected with a purity of 94%, and preferably more than 98% and more preferably 99.99%. The tea pouches comprising teabags are heat sealed through a continuous band sealer. The nitrogen flushed pouches with teabags are heat sealed. These nitrogen flushed pouches/envelops with teabags are then used for the fulfillment of sales order.

According to one embodiment herein, gases for flushing are selected from a group consisting of nitrogen, carbon dioxide and argon or a mixture of inert gases. Nitrogen (N₂) gas is inert and tasteless with low solubility in both water and fats. Nitrogen is used to replace O₂ and thus inhibits oxidation or the growth of aerobic micro-organisms. According to one embodiment, the normal composition of air within a package is 21% Oxygen, 78% Nitrogen and less than 0.1% Carbon dioxide. The headspace in the pouch/envelop with teabag is modified by nitrogen gas flushing to remove the oxygen content and the atmospheric gases and to increasing the levels of nitrogen significantly to enhance the stability of biochemical components and preserve the freshness and quality of tea in modified packaging environment.

According to one embodiment herein, the gas pressure while gas flushing the teabags is maintained at 1 bar.

According to one embodiment herein, the temperature of gas while applying gas to the teabags is maintained at less than 5° C.

According to one embodiment herein, the tea bags are flushed with nitrogen, while packaging the teabags in pouches. The tea bags within a gas-tight flexible pouch is heat sealed. Absence of any residual oxidative gases, presence of nitrogen and reduced moisture-gas migration improves the storage quality of tea bags.

According to one embodiment herein, the teabags are subjected to gas flushing while packing the teabags in pouches. The teabags are put into pouches. The nitrogen flushed pouches are heat sealed.

According to one embodiment herein, the packaging material used for packing teabags and pouches include but not limited to Biaxial oriented polypropylene (BOPP), metalized polyester (MET-PET) and polyethylene (PE). The BOPP, MET-PET and PE laminates has the characteristic property of the least gas migration rate and water vapor transmission rate (WVTR).

According to one embodiment herein, the types of tea which are preserved by the gas flushing are loose leaf tea, green tea, black tea, oolong tea, white tea, blended tea comprising tea leaves procured from one or more tea estates, and blended tea comprising tea leaves procured from one or more tea estates and one or more flavoring agents or non-tea components.

According to one embodiments herein, the teabags are nitrogen gas flushed or flushed with gases or mixture of gases to reduce the exposure of tea leaf to reactive agents. The reactive agents are existing gases, residual gases, oxygen, moisture, heat and light. The tea in absence of reactive agents does not undergo the degradation. The tea after subjecting to gas flushing has prolonged shelf life with intact tea quality.

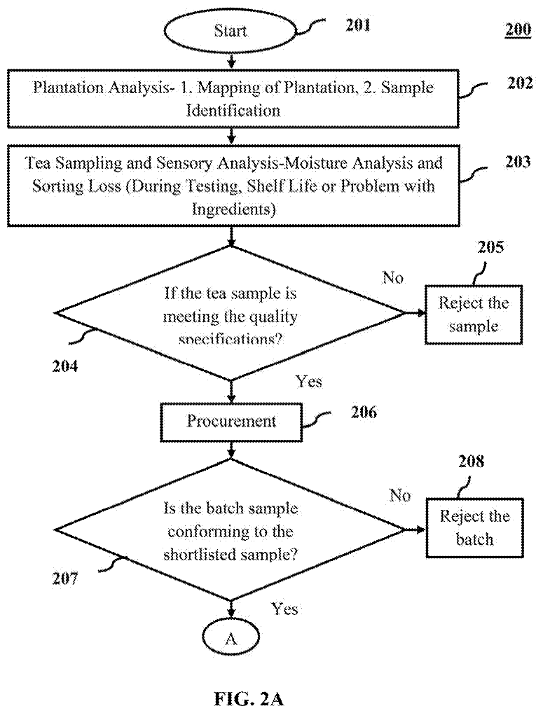

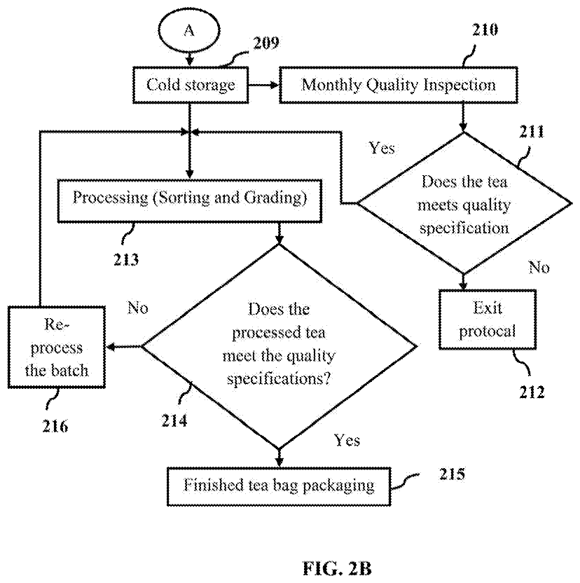

FIG. 2A-2B is flow chart collectively illustrating the steps of straight tea bag packaging, according to one embodiment herein. The process of quality inspection of tea starts (201) with plantation analysis (202) comprising of 1) mapping of plantation and 2) sample identification. After the mapping of plantation and sample identification, the tea sampling and sensory analysis (203) of tea is performed. The tea sampling and sensory analysis (203) comprises 1) moisture analysis and sorting loss (during testing, shelf life or problem with ingredients) 2) grading of tea. The next step is to check whether the sample meets the quality specifications (204). When the tea sample does not meet the quality specification, then the tea sample is rejected (205). When the tea sample meets the quality specifications, then the tea is procured (206). The batch sample collected from the procured tea is analyzed to confirm whether the batch sample matches with shortlisted tea sample (207). The analysis is done based on the physiochemical properties of the tea and non-tea ingredients. The physical property analysis of tea comprises analyzing the tea in three stages i.e. dry leaf, infusion and liquor. The chemical analysis of tea comprises determination of moisture content, ash content, liquor content, polyphenols, caffeine content etc. When the batch sample does not match with shortlisted tea sample, then the entire batch is rejected (208). When the batch sample matches with shortlisted tea sample, then the entire batch is subjected to warehousing (209). After storing the procured tea leaf in cold storage (209), the tea batch is subjected to monthly quality inspection (210). When the tea does not meets the quality specifications (211), then the protocol is exited (212). When the tea meets the quality specification, then tea is subjected to processing (213). The processing comprises sorting and grading. After processing (213), the tea is analyzed to check whether the processed tea meets the quality specification or parameter or criteria (214). When the tea does not meet the quality specification, then the entire batch is re-processed (216). When the tea meets the quality specification, then the finished tea bag is packaged (215). The finished product or the tea bags are packaged into pouches after nitrogen flushing.

According to one embodiment herein, the “dry leaf” analysis of tea comprises determination of bloom and aroma intensity. The aroma is determined on a scale of high aroma and low aroma. The “infusion” analysis of tea comprises determination of color and aroma intensity. The color is determined on a scale of bright and &ill. The aroma intensity is determined on a scale of high and low. The “liquor analysis” of tea comprises determination of color, aroma intensity, astringency, strength, flavor, bitterness, body and aftertaste. The color is determined on a scale of bright and dull. The aroma intensity is determined on a scale of high and low. The astringency is determined on a scale of low and high. The strength is determined on a scale of high and low. The flavor is determined on a scale of strong and plain. The bitterness is determined on a scale of low and high. The body is determined on a scale of high and low. The aftertaste is determined on a scale of lingering and short.

According to one embodiment herein, the scores are assigned for analysis of dry leaf, infusion and liquor. The final score is calculated for each tea sample to rate the tea sample. The final score is assigned by considering 20% of dry leaf score, 20% of wet leaf score or infusion score and 60% liquor score.

According to one embodiment herein, the chemical analysis of a tea sample comprises determination of ash content, liquor content, polyphenol analysis and determination and quantification of catechin. The liquor content analysis comprises analysis of polar content. The polar content of tea react with water and come out of tea particles. The polyphenols are analyzed by spectrophotometry. In the quantification of catechin, the theaflavin and thearubigin content is determined.

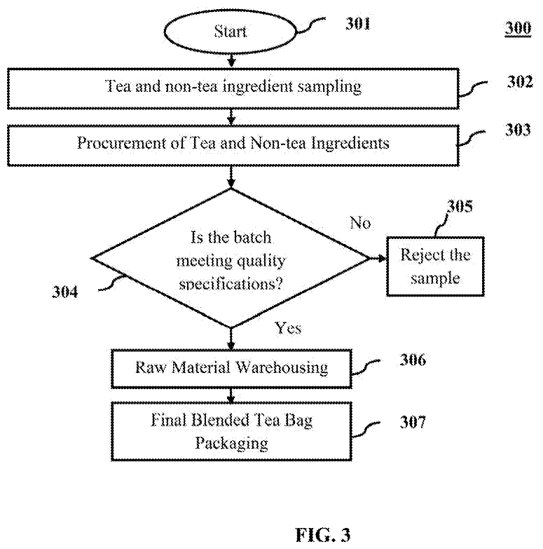

FIG. 3 illustrates a flow chart collectively explaining the steps of blended tea bag packaging, according to one embodiments herein. The process of quality inspection and packing the tea blend start (301) with sampling of tea and non-tea ingredients (302). The next step is procurement of tea and non-tea ingredients (303). After procuring non-tea ingredients, the batch of non-tea ingredients is analyzed to check whether the batch of non-tea ingredients meets the required quality specifications (304). When the batch does not meet the required quality specification, the sample is rejected (305). When the batch meets the required quality specifications, the raw materials (tea and non-tea ingredients) are sent and stored in a raw material (RM) warehousing (306). After storing tea and non-tea ingredients in a warehousing, a final blend batch is developed and packed (307). The finished product or the blended tea is packed in tea bags after nitrogen flushing.

The embodiments herein provide a method of storage and technique of packaging and non-reactive environment for teabags to enhance the stability of biochemical components and increase the shelf life of tea and preserve the freshness and quality.

The embodiments herein provide a method for treating the teabags with a combination of gas flushing in a storage environment to provide a non-reactive environment for tea thereby preserving the freshness, aroma, flavor and color.

The embodiments herein provide a method of packaging teabags to arrest oxygen, moisture induced reactive changes in the tea to avoid degradation of flavoring and aromatic compounds.

The embodiments herein provide a modified atmospheric packaging for prolonging the stability and shelf life of made tea.

The embodiments herein provide a method of packaging teabags without adding chemical agents, preservatives and additives to tea.

The embodiments herein provide a method of packaging teabags involves subjecting the teabags to gas flushing to eliminate side effect on consumer or physiochemical nature of tea.

Therefore, the method disclosed in the embodiments herein helps in maintaining original quality of tea with minimal biochemical and oxidative changes during storage by inhibiting microbial growth. Thus, the tea supplied to the customer is maintained as fresh as on day one with no significant changes in freshness and quality.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims. Although the embodiments herein are described with various specific embodiments, it will be obvious for a person skilled in the art to practice the embodiments herein with modifications.

What is claimed is:

1. A method for storage and packaging of blended/non-blended tea by providing a non-reactive environment for tea bags to preserve freshness, maintain quality, enhance stability and to increase a shelf life of tea by maintaining a stability of bio-chemical components, the method comprising the steps of:
procuring tea from one or more tea gardens through a mapping of tea plantation, and wherein the tea is procured at a plurality of flush timings to obtain tea with varying liquor characteristics;
identifying a batch sample from the procured tea and confirming a matching of the batch sample with a previously shortlisted tea sample based on a plurality of predetermined quality specifications, and wherein the procured tea is rejected when the batch sample does not match with the shortlisted tea sample;
storing the procured tea in a cold storage for retaining a quality, composition, flavour and colour of the procured tea;
processing the procured tea using sorting and grading techniques, and wherein the tea is subjected to a quality check before and after processing the procured tea to meet the plurality of predetermined quality specifications, and wherein the tea is reprocessed when the processed tea does not meet the plurality of predetermined quality specifications;
packaging the processed tea in tea bags, wherein the tea bags are gas flushed to remove existing gases and residual gases in the tea bag environment to avoid oxidative deterioration, and wherein the tea bag is gas flushed using inert gases for inhibiting growth of aerobic micro-organisms, and wherein the tea bags are nitrogen gas flushed; and
individually packaging each tea bags in pouch, and wherein the pouches are gas flushed and heat sealed during packaging for enhancing the stability and increasing the shelf life of tea, and wherein each tea bag is gas flushed separately.

2. The method according to claim 1, wherein the plurality of predetermined quality specifications comprise physical, chemical and microbial quality specifications that the tea and tea bags/pouches need to meet at various stages of tea processing.

3. The method according to claim 2, wherein the plurality of physical quality specifications comprise non-contamination of tea from living insects, moulds, dead insects, insect fragments and rodent as visible to naked eye, flavour of tea free from any off odour, taint and mustiness, sensory evaluation of the tea greater than 7 points on a scale of 10 points, porosity of tea bag material, tensile strength of a tea bag tag, thickness of pouch material and intactness of sealing.

4. The method according to claim 3, wherein one or more sensory parameters considered during sensory evaluation of tea comprise dry leaf bloom, dry leaf aroma intensity, wet leaf colour, wet leaf aroma intensity, liquor colour, liquor aroma intensity, liquor astringency, liquor strength, liquor flavor, liquor bitterness, and liquor after taste.

5. The method according to claim 2, wherein the plurality of chemical quality specifications comprise a moisture content of tea between 2% to 5%, a water soluble ash of tea in the range of 4% to 8%, an acid insoluble ash of tea less than 1% and a water extract of tea more than 32%.

6. The method according to claim 2, wherein the plurality of microbial quality specifications comprise an absence of pathogenic micro-organisms in the tea and a total plate count of tea below 100000 cfu/g.

7. The method according to claim 1, wherein the gases used for flushing the tea bags and pouches are nitrogen, carbon dioxide, argon and a mixture of inert gases, and wherein the gas pressure during gas flushing of tea bags is maintained at about 1 bar and temperature of gas while applying gas to the tea bags is maintained below 5° C.

8. The method according to claim 1, further comprises procuring non-tea ingredients (flavoring agents), through the process of sampling, subjecting the non-tea ingredients to a quality check and storing the non-tea ingredients in a cold storage.

9. The method according to claim 1, further comprises developing a blended tea by blending stored tea and non-tea ingredients, and wherein the blended tea is packaged in tea bags by gas flushing.

10. The method according to claim 1, further comprising developing blended tea by blending tea leaves procured from one or more tea estates.

11. The method according to claim 1, further comprising developing blended tea by blending tea leaves procured from one or more tea estates and one or more non-tea ingredients, and wherein the one or more non-tea ingredients are flavoring agents.

12. The method according to claim 1, wherein a packaging material used for making tea bags and pouches comprise biaxial oriented polypropylene (BOPP), metalized polyester (MET-PET) and polyethylene (PE).

13. The method according to claim 1, wherein the packaged tea is gas flushed and delivered to a consumer with a freshness similar to a freshness of tea on the day of manufacture.

14. A computer implemented method comprising instructions stored on a non-transitory computer readable storage medium and executed on a computing system provided with a hardware processor and memory, for storage and packaging of blended/non-blended tea by providing a non-reactive environment for tea bags to preserve freshness, maintain quality, enhance stability and to increase a shelf life of tea by maintaining a stability of bio-chemical components, the method comprising the steps of:
procuring tea from one or more tea gardens through a mapping of tea plantation with a user computing device, and wherein the tea is procured at a plurality of flush timings to obtain tea with varying liquor characteristics;
identifying a batch sample from the procured tea and confirming a matching of the batch sample with a previously shortlisted tea sample based on a plurality of predetermined quality specifications with the user computing system, and wherein the procured tea is rejected when the batch sample does not match with the shortlisted tea sample;
storing the procured tea in a cold storage for retaining a quality, composition, flavour and colour of the procured tea;
processing the procured tea using sorting and grading techniques, in a processing station and wherein the tea is subjected to a quality check before and after processing the procured tea to meet the plurality of predetermined quality specifications, and wherein the tea is reprocessed when the processed tea does not meet the plurality of predetermined quality specifications;
packaging the processed tea in tea bags in the processing station, wherein the tea bags are gas flushed to remove existing gases and residual gases in the tea bag environment to avoid oxidative deterioration, and wherein the tea bag is gas flushed using inert gases for inhibiting growth of aerobic micro-organisms, and wherein the tea bags are nitrogen gas flushed; and
packaging the tea bags in pouches in the processing station, and wherein the pouches are gas flushed and heat sealed during packaging for enhancing the stability and increasing the shelf life of tea, and wherein each tea bag is gas flushed separately.

15. The method according to claim 14, wherein the plurality of predetermined quality specifications comprise physical, chemical and microbial quality specifications that the tea and tea bags/pouches need to meet at various stages of tea processing.

16. The method according to claim 15, wherein the plurality of physical quality specifications comprise non-contamination of tea from living insects, moulds, dead insects, insect fragments and rodent as visible to naked eye, flavour of tea free from any off odour, taint and mustiness, sensory evaluation of the tea greater than 7 points on a scale of 10 points, porosity of tea bag material, tensile strength of a tea bag tag, thickness of pouch material and intactness of sealing.

17. The method according to claim 15, wherein one or more sensory parameters considered during sensory evaluation of tea comprise dry leaf bloom, dry leaf aroma intensity, wet leaf colour, wet leaf aroma intensity, liquor colour, liquor aroma intensity, liquor astringency, liquor strength, liquor flavor, liquor bitterness, and liquor after taste.

18. The method according to claim 15, wherein the plurality of chemical quality specifications comprise a moisture content of tea between 2% to 5%, a water soluble ash of tea in the range of 4% to 8%, an acid insoluble ash of tea less than 1% and a water extract of tea more than 32%.

19. The method according to claim 15, wherein the plurality of microbial quality specifications comprise an absence of pathogenic micro-organisms in the tea and a total plate count of tea below 100000 cfu/g.

20. The method according to claim 14, wherein the gases used for flushing the tea bags and pouches are nitrogen, carbon dioxide, argon and a mixture of inert gases, and wherein the gas pressure during gas flushing of tea bags is maintained at about 1 bar and temperature of gas while applying gas to the tea bags is maintained below 5° C.

21. The method according to claim 14, further comprises procuring non-tea ingredients (flavoring agents), through the process of sampling, subjecting the non-tea ingredients to a quality check and storing the non-tea ingredients in a cold storage.

22. The method according to claim 14, further comprises developing a blended tea by blending stored tea and non-tea ingredients, and wherein the blended tea is packaged in tea bags by gas flushing.

23. The method according to claim 14, further comprising developing blended tea by blending tea leaves procured from one or more tea estates.

24. The method according to claim 14, further comprising developing blended tea by blending tea leaves procured from one or more tea estates and one or more non-tea ingredients, and wherein the one or more non-tea ingredients are flavoring agents.

25. The method according to claim 14, wherein a packaging material used for making tea bags and pouches comprise biaxial oriented polypropylene (BOPP), metalized polyester (MET-PET) and polyethylene (PE).
